(19) United States
(12) Patent Application Publication
(10) Pub. No.: US 2026/0359769 A1
(43) Pub. Date: Nov. 12, 2026

(54) METHOD AND SYSTEM FOR MODULAR ARTIFICIAL INTELLIGENCE (AI) CASH FORECASTING

(71) Applicant: Panax Tech Ltd., Tel Aviv (IL)

(72) Inventor: Yosef Haim ITZKOVICH, Tel Aviv (IL)

(73) Assignee: Panax Tech Ltd., Tel Aviv (IL)

(21) Appl. No.: 19/669,018

(22) Filed: May 6, 2026

Related U.S. Application Data
(60) Provisional application No. 63/801,962, filed on May 8, 2025.

(51) Int. Cl. G06Q 10/067; G06Q 10/04

(52) U.S. Cl. CPC G06Q 10/0674; G06Q 10/04

(57) ABSTRACT

A method and system for forecasting cash balances of a business. The method may include the following steps: aggregating, on a computer memory, cash transactions made by the business over a specified period in the past; categorizing, using a computer processor, at least some of the cash transactions, with a respective one of a plurality of categories of financial data, to yield categorized cash transactions; and generating, using the computer processor, a cash forecast for the business over a specified period in the future, responsive to a selection of one of a plurality of forecasting methodologies, and applying the selected methodology to the categorized cash transactions, wherein the forecasting methodologies takes into account said categorizing.

### CROSS-REFERENCE TO RELATED APPLICATIONS

This application claims the benefit of U.S. Provisional Patent Application No. 63/801,962, filed May 8, 2025, which is incorporated by reference herein in its entirety.

### FIELD OF THE INVENTION

The present invention relates generally to the field of data processing, and more particularly to cash forecasting using artificial intelligence.

### BACKGROUND OF THE INVENTION

While online banking for business users provides accurate transactional data, it lacks linking the transactions to the cashflow classification of the business. Traditionally, accountants and finance persons go over bank transactions periodically and attempt to label or tag the bank transaction with additional data based on their knowledge of the cashflow of the specific business.

Some solutions for building cashflow management platforms are starting to appear on the market, in order to help businesses make data-driven decisions to support both daily and long-term growth decisions, solving huge pain for finance teams.

One of the challenges of a cashflow management platform is to provide cash forecasting based on the accumulated financial data. Conventional systems that merely collect transaction records or apply monolithic spreadsheet-style projections often consume excessive computing resources, require repeated full-dataset recalculation, and fail to preserve meaningful transaction-level structure needed for accurate machine processing. As a result, such systems may produce forecasts that are computationally inefficient, difficult to update, and lacking in technical transparency. An accurate and transparent cashflow forecasting system should therefore improve not only business decision-making, but also the functioning of the forecasting computer system itself by organizing, processing, and updating financial data in a more efficient and technically coherent manner.

### SUMMARY OF THE INVENTION

In order to address the aforementioned challenges of generating a cashflow forecast, it has been suggested by the inventor of the present invention to categorize the cash transactions of a business and then generate the cashflow forecast in a bottom-up manner by aggregating the cash transactions while factoring in scope, duration, and category, and then adding up the forecasted cashflow for each category to form a holistic forecast for all categories. In some embodiments, this architecture improves computer implementation of forecasting by structuring transaction data into machine-processable categories and sub-categories that permit modular forecasting, selective re-computation, and scenario-based recalculation without requiring undifferentiated reprocessing of all available financial records.

According to some embodiments of the present invention, a method and a system for forecasting cash balances of a business are provided herein. The method may include the following steps: aggregating, on a computer memory, cash transactions made by the business over a specified period in the past; categorizing, using a computer processor, at least some of the cash transactions, with a respective one of a plurality of categories of financial data, to yield categorized cash transactions; and generating, using the computer processor, a cash forecast for the business over a specified period in the future, responsive to a selection of one of a plurality of forecasting methodologies, and applying the selected methodology to the categorized cash transactions, wherein the forecasting methodologies take into account said categorizing. In some embodiments, the categorizing and methodology selection are implemented as cooperating machine-executable modules that transform raw transaction records into a structured forecast data representation that improves processor efficiency, memory utilization, and the ability of the system to generate revised forecasts in response to changed inputs.

The system may implement the aforementioned method in a client server architecture and may offer a platform for cashflow forecasting as a software as a service (SaaS).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high-level block diagram illustrating a system for forecasting cash balances of a business, in accordance with embodiments of the present invention; and

FIG. 2 is a high-level flowchart illustrating a method of forecasting cash balances of a business, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In the foregoing detailed description, numerous specific details are set forth in order to provide an understanding of the invention. However, it will be understood by those skilled in the art that the invention can be practiced without these specific details. In other instances, well-known methods, procedures, and components, modules, units, and/or circuits have not been described in detail so as not to obscure the invention. Some features or elements described with respect to one embodiment can be combined with features or elements described with respect to other embodiments.

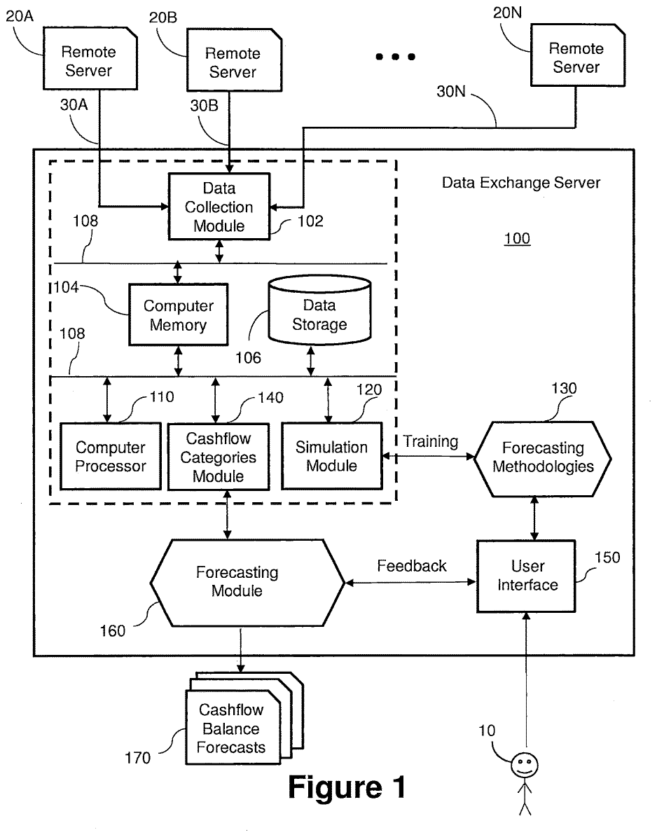

FIG. 1 is a high-level block diagram illustrating a system for forecasting cash balances of a business. Data exchange server 100 may include a computer memory 104 configured to aggregate, possibly using data collection module 102, cash transactions made by the business over a specified period in the past, wherein cash transaction data may be collected over various data connections 30A-30N with a plurality of remote servers 20A-20N. In some embodiments, data collection module 102 normalizes transaction records received from heterogeneous external systems into a common machine-readable structure, thereby reducing inconsistencies in downstream processing and enabling the forecasting engine to process the aggregated data using a unified internal representation.

Data exchange server 100 may further include a computer processor 110 connected to computer memory 104 and computer storage 106 over computer bus 108. Computer processor 110 may be configured to categorize at least some of the cash transactions, possibly using cashflow categories module 140, with a respective one of a plurality of categories of financial data, to yield categorized cash transactions. In some embodiments, cashflow categories module 140 generates and maintains category-linked data objects that associate transaction attributes with forecast-driving parameters, such that subsequent forecasting operations may be performed on the category-linked data objects rather than repeatedly parsing raw transaction inputs, thereby reducing processing complexity and improving system responsiveness.

In some embodiments, the computer processor executes a categorization pipeline that maps raw transaction records into category-linked data objects using one or more classification rules, learned models, lookup structures, or combinations thereof. Each category-linked data object may include an association between a transaction-derived input and one or more forecast-driving attributes, such as expected recurrence, expected delay, counterparty type, entity scope, or scenario sensitivity, thereby permitting downstream forecasting modules to access structured attributes without reprocessing the underlying raw transaction record.

In some embodiments, the category-linked data objects are stored in a memory structure that preserves relationships among transactions, categories, sub-categories, and business entities through pointers, keys, links, or indexed associations. Preservation of such relationships may permit the forecasting module to generate category-level, entity-level, and consolidated forecasts from a common underlying structured representation, thereby improving interoperability among software modules and reducing duplicative storage of the same transaction information.

Computer processor 110 may be further configured, possibly using forecasting module 160, to generate a cash forecast 170 for the business over a specified period in the future, responsive to a selection of one of a plurality of forecasting methodologies 130, and applying the selected methodology to the categorized cash transactions, wherein each one of the forecasting methodologies takes into account said categorizing. In some embodiments, forecasting module 160 operates on modular subsets of the categorized cash transactions associated with respective categories, scopes, or forecast intervals, such that the system can selectively execute only the portions of the forecasting workflow affected by newly received data or modified user inputs, thereby improving computational efficiency relative to systems that recalculate an entire enterprise forecast from unstructured historical data.

In some embodiments, forecasting module 160 includes a forecast-execution engine configured to receive a methodology selection and to invoke only a corresponding forecasting routine associated with one or more selected categories, scopes, intervals, or scenarios. The forecast-execution engine may generate a revised cash forecast by applying the corresponding forecasting routine to previously stored category-linked data objects and, where available, previously stored intermediate forecast results, thereby reducing full-model re-computation.

In some embodiments, the forecasting module 160 generates the cash forecast as a multi-level forecast data structure comprising category-level values, sub-category-level values, entity-level values, consolidated values, and time-bucket values. The multi-level forecast data structure may be updated at one level and propagated to one or more dependent levels through stored dependency relationships, thereby enabling technically efficient updating of a consolidated forecast when fewer than all underlying inputs have changed.

According to some embodiments of the present invention, the computer processor is configured to generate the forecast by simulating, possibly using simulation module 120, the cash forecast for the business over a specified period in the future by determining drivers that affect the forecast and by enabling adjustment of the drivers and review of a plurality of scenarios leading to different outcomes of the cash forecast. In some embodiments, simulation module 120 stores driver values and scenario-specific adjustments in a structured form linked to the categorized cash transactions, so that alternative scenarios may be computed through parameter variation of the structured data representation rather than through redundant recreation of the underlying transaction dataset, thereby reducing storage duplication and processing overhead.

In some embodiments, simulation module 120 stores a baseline scenario and one or more alternative scenarios as parameter differentials relative to the baseline scenario rather than as fully duplicated forecast datasets. The computer processor may generate an alternative scenario by applying one or more stored parameter differentials to a shared structured forecast representation, thereby reducing memory usage and storage duplication relative to maintaining separate full copies of scenario-specific transaction data.

In some embodiments, the simulation module 120 is configured to identify, for a requested scenario adjustment, a subset of categories, drivers, or time intervals affected by the scenario adjustment and to recompute forecast results for the identified subset while preserving previously computed forecast results for unaffected subsets. Such targeted scenario execution may improve responsiveness of the forecasting platform and reduce processing overhead during iterative user-driven scenario analysis.

According to some embodiments of the present invention, computer processor 110 is configured to generate the cash forecast for the business over a specified period in the future in a bottom-up manner by carrying out first the categorizing for at least some of the transactions, and later carrying out the aggregating of the cash transactions using variable granularities of at least one of: duration of forecast, and scope of transaction, thereby generating the forecast of the cash transactions as a superposition of the categorized transactions aggregated in view of the variable granularities. In some embodiments, the use of variable granularities enables the system to compute selected forecast segments at daily, weekly, or monthly resolution and at entity, subsidiary, or enterprise scope without requiring identical processing resolution for all portions of the forecast, thereby improving the operation of the forecasting computer system by reducing unnecessary computation and memory consumption.

According to some embodiments of the present invention, data exchange server 100 may further include a user interface 150 configured to present the cash forecast to a human user 10 in a graphical format.

According to some embodiments of the present invention, computer processor 110 may be further configured to enable human user 10 to modify said cash forecast in the graphical format by changing at least one of: time frame of cashflow forecast; scope of cash transactions; and structure of the business. In some embodiments, the user modifications are translated into updates to the underlying category-linked data objects and forecast parameters, such that the system performs targeted re-computation of affected forecast portions while preserving unchanged forecast portions, thereby improving update speed and reducing system complexity.

According to some embodiments of the present invention, the forecasting methodologies 130 are implemented as distinct machine-executable forecasting components that operate on a shared categorized data representation. Because each methodology operates on the shared categorized data representation, the system may switch between methodologies, combine outputs from multiple methodologies, or incrementally update methodology-specific forecast results without reconstructing the underlying transaction dataset, thereby improving interoperability between forecasting components and reducing duplication of data processing operations.

In some embodiments, the shared categorized data representation comprises a plurality of machine-readable forecast objects, each forecast object corresponding to at least one transaction, category, sub-category, business entity, time interval, or combination thereof, and storing one or more values selected from transaction amount, timing parameter, recurrence parameter, scope identifier, scenario identifier, dependency identifier, and methodology-selection parameter. The forecast objects may be indexed in computer memory according to category, time interval, and business scope, such that the computer processor may retrieve and update less than all stored forecast objects when generating a revised forecast.

In some embodiments, the system maintains, in computer storage, a dependency mapping between (i) respective forecast objects or category-linked data objects and (ii) one or more forecasting methodologies, drivers, scenarios, user-interface controls, or output portions of the cash forecast. Responsive to a detected change in an input transaction, driver value, scope selection, time-frame selection, or business structure parameter, the computer processor may identify, via the dependency mapping, a subset of forecast objects affected by the detected change and may recompute the cash forecast using the identified subset without recomputing unaffected portions of the cash forecast.

In some embodiments, the categorized cash transactions are transformed into a structured feature set for use by one or more forecasting engines, wherein the structured feature set comprises normalized numerical, temporal, categorical, and relationship-based features derived from the categorized cash transactions. By deriving and storing the structured feature set in advance of forecast generation, the system may reduce repetitive parsing of source transaction data, reduce processor load during execution of forecasting methodologies, and improve consistency of input supplied to different forecasting methodologies.

In some embodiments, the system stores intermediate forecast results for respective categories, sub-categories, entities, time intervals, or scenarios in a cache or other computer-readable memory structure. When a revised forecast is requested, the processor may preserve previously computed intermediate forecast results associated with unchanged inputs and selectively invalidate only intermediate forecast results associated with changed inputs, thereby enabling incremental re-computation of the cash forecast and reducing processing latency.

In some embodiments, the system applies one or more data-validation and normalization operations to externally received transaction data before categorization, including at least one of duplicate detection, field standardization, missing-value handling, currency normalization, account mapping, and timestamp alignment. Such preprocessing may improve machine processing of the transaction data by reducing inconsistencies among heterogeneous data sources and by generating a standardized input structure for downstream forecasting operations.

By way of a non-limiting example, a cashflow forecast may be generated based on of the following two stage process:

First, aggregating all cash transaction based on granular labeling which is either by category or by sub categories.
Then, allowing planning and forecasting the future with various methods:
1. Based on historical data—for example 3/6/12/24 months averages.
2. Based on other category, for example based on a business assumption that collection is
3 times the amount of money invested in marketing
3. Based on ERP data
4. Based on AI generated forecast
5. Allowing forecasting in different time frames, for example: daily/weekly/monthly
6. Allowing forecasting in different scopes: er entire parent company or per entity (subsidiary), which is consolidated and then can also allow both per subsidiary or for all company

According to some embodiments of the present invention, the plurality of forecasting methodologies may include at least one of: a statistical data-based forecast using one or more time periods; a category-based forecast, wherein the statistical data-based forecast is adjusted based on a predefined relationship between categories; an Enterprise Resource Planning (ERP)-based forecast, wherein the ERP-based forecast is based on data extracted from the ERP system of the business; and an artificial intelligence (AI)-generated forecast, wherein the AI forecast is generated using an artificial intelligence model that analyzes historical and other relevant data. In some embodiments, the AI-generated forecast is produced by a model that receives as input the categorized cash transactions and one or more category-linked parameters, such that the model operates on structured financial features derived by the system rather than on raw transactional text or undifferentiated transaction logs, thereby improving signal extraction, reducing noise in model input, and improving the technical operation of the forecasting engine.

In some embodiments, when the selected forecasting methodology comprises an AI-generated forecast, the artificial intelligence model receives as input a feature representation generated from the categorized cash transactions, wherein the feature representation preserves at least one of temporal sequencing, category membership, scope membership, recurrence behavior, and dependency on one or more forecast drivers. By supplying the model with the feature representation instead of raw bank transaction text or unstructured logs, the system may improve machine interpretability of the input data and improve computational efficiency of model execution.

In some embodiments, different forecasting methodologies operate on a common application programming interface or other common internal data-access layer associated with the shared categorized data representation. As a result, the system may interchange forecasting methodologies, combine outputs from multiple methodologies, or execute comparative forecast generation without reformatting the underlying transaction data for each methodology, thereby reducing conversion overhead and improving compatibility among forecasting components.

According to some embodiments of the present invention, the selection of one of a plurality of forecasting methodologies is carried out at least partially by a machine learning agent. In some embodiments, the machine learning agent is configured to evaluate one or more technical characteristics of the forecasting task, including forecast horizon, transaction density, category coverage, historical stability, and data-source availability, and to select a forecasting methodology based on such characteristics so as to reduce computational burden and improve forecast generation efficiency. In some embodiments, the machine learning agent updates methodology-selection parameters over time based on observed forecasting performance while maintaining prior learned parameter relationships for previously processed categories or scenarios, thereby supporting incremental model adaptation without requiring complete retraining for each newly received data set.

In some embodiments, the machine learning agent selects among the plurality of forecasting methodologies based on one or more system-level performance criteria in addition to forecast accuracy, the system-level performance criteria comprising at least one of expected execution time, memory consumption, data completeness, model suitability for a selected forecast horizon, and computational cost associated with a selected business scope. Accordingly, methodology selection may improve operation of the forecasting computer system by dynamically choosing a technically suitable forecasting technique for the current machine-processing context.

In some embodiments, the machine learning agent updates methodology-selection behavior using incremental learning based on newly observed forecast outcomes and system-performance data while preserving previously learned parameters associated with prior categories, scopes, or forecast intervals. Such incremental updating may reduce retraining cost and may improve stability of the forecasting platform as newly received transaction data is incorporated over time.

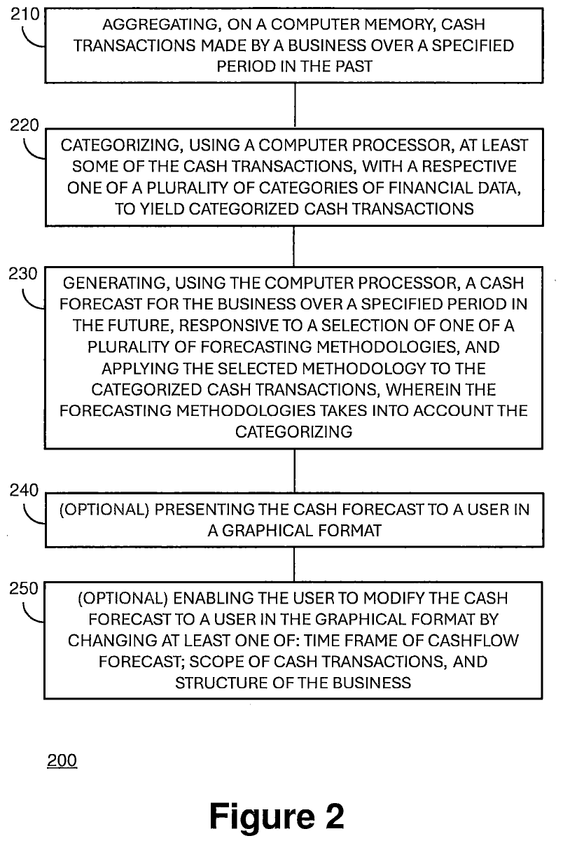

FIG. 2 is a high-level flowchart illustrating method 200 of forecasting cash balances of a business. Method 200 may include the following steps: aggregating, on a computer memory, cash transactions made by the business over a specified period in the past 210; categorizing, using a computer processor, at least some of the cash transactions, with a respective one of a plurality of categories of financial data, to yield categorized cash transactions 220; and generating, using the computer processor, a cash forecast for the business over a specified period in the future, responsive to a selection of one of a plurality of forecasting methodologies, and applying the selected methodology to the categorized cash transactions, wherein the forecasting methodologies take into account the categorizing 230. In some embodiments, steps 210-230 collectively transform externally sourced transaction data into an internally structured forecast representation that enables the computer system to execute forecasting, scenario simulation, and user-driven revision with reduced re-computation and improved processing efficiency.

In some embodiments, method 200 further comprises normalizing externally sourced transaction data into a common internal format before categorizing the cash transactions, generating category-linked data objects from the normalized transaction data, storing one or more intermediate forecast results for at least some of the category-linked data objects, and selectively recomputing only affected portions of the cash forecast in response to a changed input, changed driver, changed methodology, or changed user selection.

In some embodiments, method 200 further comprises generating a dependency mapping between forecast inputs and forecast outputs, identifying through the dependency mapping a reduced set of forecast components affected by a requested change, and executing the selected forecasting methodology on the reduced set of forecast components to generate a revised forecast.

According to some embodiments of the present invention, the selection of one of a plurality of forecasting methodologies may be carried out at least partially by a machine learning agent.

According to some embodiments of the present invention, method 200 may further include a step of presenting the cash forecast to a user in a graphical format 240.

According to some embodiments of the present invention, method 200 may further include a step of enabling the user to modify the cash forecast to a user in the graphical format by changing at least one of: time frame of cashflow forecast; scope of cash transactions, and structure of the business 250.

### Simulation of the Cashflow Forecasting

According to some embodiments of the present invention, the generating may include simulating the cash forecast for the business over a specified period in the future by determining drivers that affect the forecast and by enabling adjustment of the drivers and review of a plurality of scenarios leading to different outcomes of the cash forecast. In some embodiments, the simulation is executed by modifying driver-linked parameters within the structured forecast representation while preserving unchanged category-level data and intermediate forecast results, thereby allowing the system to compute multiple scenarios with lower storage usage and lower processing overhead than systems that rebuild each scenario independently from the full transaction history.

### Building the Cashflow Forecast Bottom-Up

According to some embodiments of the present invention, generating of the cash forecast for the business over a specified period in the future may be carried out bottom-up by first carrying out the categorizing for at least some of the transactions, and later carrying out the aggregating of the cash transactions made using variable granularities of at least one of: duration of forecast, and scope of transaction, thereby generating the forecast of the cash transactions as a superposition of the categorized transactions aggregated in view of the variable granularities.

In some embodiments, the bottom-up generation improves the functioning of the computer system by permitting localized recalculation at the level of category, sub-category, entity, time segment, or driver, instead of requiring full-model re-computation across all financial records whenever one input changes.

### Employing Various Cashflow Forecasting Methodologies

According to some embodiments of the present invention, the plurality of forecasting methodologies comprises at least one of: a statistical data-based forecast using one or more time periods; a category-based forecast, wherein the statistical data-based forecast is adjusted based on a predefined relationship between categories; an Enterprise Resource Planning (ERP)-based forecast, wherein the ERP-based forecast is based on data extracted from the ERP system of the business; and an artificial intelligence (AI)-generated forecast, wherein the AI forecast is generated using an artificial intelligence model that analyzes historical and other relevant data.

In some embodiments, these methodologies are not merely alternative business rules, but are distinct computer-implemented techniques for processing categorized financial data, and the system selectively invokes one or more of the methodologies in a manner that improves operation of the forecasting platform by reducing unnecessary computation, improving scalability across different business scopes, and enabling technically efficient generation of revised forecasts as additional data becomes available.

According to some embodiments of the present invention, the specification's reference to AI-generated forecasting includes implementation of one or more trained machine learning models whose operation is improved through use of the categorized transaction structure and associated forecast drivers disclosed herein. In some embodiments, the categorized transaction structure serves as a technical input framework that preserves relationships among prior transactions, categories, and forecast intervals when the model is updated with newly received financial data, thereby reducing degradation in forecasting performance across previously learned categories and improving the operation of the machine learning-based forecasting system over time.

In some embodiments, the disclosed system and method are directed to an improvement in computer-based cash forecasting technology, and not merely to organizing human financial activity. More particularly, the disclosed architecture uses categorized transaction representations, modular forecasting methodologies, variable-granularity aggregation, and parameterized scenario simulation to improve how a forecasting computer system stores, processes, updates, and presents forecast data. These improvements may include, by way of example, reduced storage duplication, reduced processing complexity, faster scenario generation, and more efficient incremental re-computation in response to modified inputs.

In some embodiments, the disclosed subject matter may be claimed in terms of a specific improvement in computer functionality arising from use of: (i) normalized transaction ingestion from heterogeneous sources; (ii) transformation of transaction records into category-linked data objects; (iii) storage of forecast data in a structured representation indexed by category, scope, interval, or scenario; (iv) dependency-based selective re-computation of less than all forecast components; (v) parameter-differential scenario simulation; and/or (vi) methodology selection based on technical processing characteristics. These features may be implemented individually or in combination.

In some embodiments, the disclosed subject matter is not limited to producing a financial estimate as such, but includes specific computer-implemented techniques for reducing repetitive parsing of transaction inputs, reducing duplicative storage of scenario data, reducing unnecessary re-computation of unaffected forecast portions, and improving processor efficiency in generating revised forecasts from changing financial data.

It is further understood that some embodiments of the present invention may be embodied in the form of a system, a method, or a computer program product. Similarly, some embodiments may be embodied as hardware, software, or a combination of both. Some embodiments may be embodied as a computer program product saved on one or more non-transitory computer-readable medium (or media) in the form of computer-readable program code embodied thereon. Such non-transitory computer-readable medium may include instructions that when executed cause a processor to execute method steps in accordance with embodiments. In some embodiments, the instructions stored on the computer-readable medium may be in the form of an installed application and in the form of an installation package.

Such instructions may be, for example, loaded by one or more processors and executed. For example, the computer-readable medium may be a non-transitory computer-readable storage medium. A non-transitory computer-readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units, and/or circuits have not been described in detail so as not to obscure the invention. Some features or elements described with respect to one embodiment can be combined with features or elements described with respect to other embodiments.

1. A method of forecasting cash balances of a business, said method comprising:
aggregating, on a computer memory, cash transactions made by the business over a specified period in the past;
categorizing, using a computer processor, at least some of the cash transactions, with a respective one of a plurality of categories of financial data, to yield categorized cash transactions; and
generating, using the computer processor, a cash forecast for the business over a specified period in the future, responsive to a selection of one of a plurality of forecasting methodologies, and applying the selected methodology to the categorized cash transactions, wherein the forecasting methodologies take into account said categorizing.

2. The method of claim 1, wherein the generating comprises simulating the cash forecast for the business over a specified period in the future by determining drivers that affect the forecast and by enabling adjustment of the drivers and review of a plurality of scenarios leading to different outcomes of the cash forecast.

3. The method of claim 1, wherein the generating of the cash forecast for the business over a specified period in the future is carried out bottom-up by first carrying out the categorizing for at least some of the transactions and later carrying out the aggregating of the cash transactions using variable granularities of at least one of: duration of forecast; and scope of transaction, thereby generating the forecast of the cash transactions as a superposition of the categorized transactions aggregated in view of the variable granularities.

4. The method of claim 1, wherein the plurality of forecasting methodologies comprises at least one of: a statistical data-based forecast using one or more time periods; a category-based forecast, wherein the statistical data-based forecast is adjusted based on a predefined relationship between categories; an Enterprise Resource Planning (ERP)-based forecast, wherein the ERP-based forecast is based on data extracted from the ERP system of the business; and an artificial intelligence (AI)-generated forecast, wherein the AI forecast is generated using an artificial intelligence model that analyzes historical and other relevant data.

5. The method of claim 1, wherein the selection of one of a plurality of forecasting methodologies is carried out at least partially by a machine learning agent.

6. The method according to claim 1, further comprising presenting the cash forecast to a user in a graphical format.

7. The method according to claim 6, further comprising enabling the user to modify said cash forecast in the graphical format by changing at least one of: time frame of cashflow forecast; scope of cash transactions; and structure of the business.

8. A system for forecasting cash balances of a business, said system comprising:
a computer memory configured to aggregate cash transactions made by the business over a specified period in the past;
a computer processor configured to:
categorize at least some of the cash transactions, with a respective one of a plurality of categories of financial data, to yield categorized cash transactions; and
generate a cash forecast for the business over a specified period in the future, responsive to a selection of one of a plurality of forecasting methodologies, and apply the selected methodology to the categorized cash transactions, wherein each one of the forecasting methodologies takes into account said categorizing.

9. The system of claim 8, wherein the computer processor is configured to generate the forecast by simulating the cash forecast for the business over a specified period in the future by determining drivers that affect the forecast and by enabling adjustment of the drivers and review of a plurality of scenarios leading to different outcomes of the cash forecast.

10. The system of claim 8, wherein the computer processor is configured to generate the cash forecast for the business over a specified period in the future in a bottom-up manner by carrying out first the categorizing for at least some of the transaction, and later carrying out the aggregating of the cash transactions made using variable granularities of at least one of: duration of forecast, and scope of transaction, thereby generating the forecast of the cash transaction as a superposition of the categorized transactions aggregated in view of the variable granularities.

11. The system according to claim 8, wherein the plurality of forecasting methodologies comprises at least one of: statistical data-based forecast using one or more time periods; category-based forecast, wherein the statistical data-based forecast is adjusted based on a predefined relationship between categories, an Enterprise Resource Planning (ERP) based forecast, wherein the ERP based forecast is based on data extracted from the ERP system of the business; and an artificial intelligence (AI) generated forecast, wherein the AI forecast is generated using an artificial intelligence model that analyses historical and other relevant data.

12. The system of claim 8 wherein the selection of one of a plurality of forecasting methodologies is carried out at least partially by a machine learning agent.

13. The system of claim 8, further comprising a user interface configured to present the cash forecast to a user in a graphical format.

14. The system of claim 13, wherein the computer processor is further configured to enable the user to modify said cash forecast to a user in the graphical format by changing at least one of: time frame of cashflow forecast; scope of cash transactions, and structure of the business.

15. A non-transitory computer-readable medium storing instructions that, when executed by one or more processors, cause a system to perform a method of forecasting cash balances of a business, the method comprising:
aggregating, on a computer memory, cash transactions made by the business over a specified period in the past;
categorizing, using a computer processor, at least some of the cash transactions, with a respective one of a plurality of categories of financial data, to yield categorized cash transactions; and
generating, using the computer processor, a cash forecast for the business over a specified period in the future, responsive to a selection of one of a plurality of forecasting methodologies, and applying the selected methodology to the categorized cash transactions, wherein the forecasting methodologies take into account said categorizing.

16. The non-transitory computer-readable medium of claim 15, wherein the generating comprises simulating the cash forecast for the business over a specified period in the future by determining drivers that affect the forecast and by enabling adjustment of the drivers and review of a plurality of scenarios leading to different outcomes of the cash forecast.

17. The non-transitory computer-readable medium of claim 15, wherein the generating of the cash forecast for the business over a specified period in the future is carried out bottom-up by first carrying out the categorizing for at least some of the transactions and later carrying out the aggregating of the cash transactions using variable granularities of at least one of: duration of forecast; and scope of transaction, thereby generating the forecast of the cash transactions as a superposition of the categorized transactions aggregated in view of the variable granularities.

18. The non-transitory computer-readable medium of claim 15, wherein the plurality of forecasting methodologies comprises at least one of: a statistical data-based forecast using one or more time periods; a category-based forecast, wherein the statistical data-based forecast is adjusted based on a predefined relationship between categories; an Enterprise Resource Planning (ERP)-based forecast, wherein the ERP-based forecast is based on data extracted from the ERP system of the business; and an artificial intelligence (AI)-generated forecast, wherein the AI forecast is generated using an artificial intelligence model that analyzes historical and other relevant data.

19. The non-transitory computer-readable medium of claim 15, wherein the selection of one of the plurality of forecasting methodologies is carried out at least partially by a machine learning agent.

20. The non-transitory computer-readable medium of claim 15, wherein the method further comprises presenting the cash forecast to a user in a graphical format.
